(19) United States
(12) Patent Application Publication
(10) Pub. No.: US 2022/0371591 A1
(43) Pub. Date: Nov. 24, 2022

(54) SMART TORQUE - MAPPING BASED POWERTRAIN CONTROLLER

(71) Applicant: GM GLOBAL TECHNOLOGY OPERATIONS LLC, Detroit, MI (US)

(72) Inventors: David Allen Craig, Macomb Twp., MI (US); Jason R. Ekelmann, Royal Oak, MI (US)

(21) Appl. No.: 17/324,414

(22) Filed: May 19, 2021

(51) Int. Cl. B60W 30/182; G01C 21/00; B60W 40/072; B60W 10/22; B60W 10/04

(52) U.S. Cl. CPC B60W 30/182; G01C 21/3822; B60W 40/072; B60W 10/22; B60W 10/04; B60W 2710/0666; B60W 2710/083; B60W 2552/15; B60W 2556/45

(57) ABSTRACT

A method of controlling operation of a vehicle includes monitoring at least one of a location and a route of the vehicle when the vehicle is in a first operating state, receiving map data related to an area around at least one of the location and the route, and identifying, based on the map data, one or more map attributes indicative of one or more features of the area. The method also includes comparing the one or more map attributes to at least one reference attribute, and based on the one or more map attributes matching the at least one reference attribute, causing the vehicle to enter a second operating state when the vehicle is in the area.

### INTRODUCTION

The subject disclosure relates to control of vehicle behavior using map data.

Many vehicles, including gas vehicles and electric vehicles, have capabilities that may or may not be appropriate for various geographical areas or features of such areas. For example, vehicles can make significant amounts of horsepower and torque available to a driver. While this is beneficial for vehicle performance, the amount of power available could present a potential safety risk, particularly in geographic areas that have high population densities (e.g., cities, residential neighborhoods). In other examples, specific vehicle operating modes may not be appropriate for all areas, or may only be appropriate under specific circumstances. Accordingly, it is desirable to provide a system that can adjust vehicle operating states and/or vehicle features in response to changes in a surrounding area, for example, to increase safety, enhance performance and/or increase drivability.

### SUMMARY

In one exemplary embodiment, a method of controlling operation of a vehicle includes monitoring at least one of a location and a route of the vehicle when the vehicle is in a first operating state, receiving map data related to an area around at least one of the location and the route, and identifying, based on the map data, one or more map attributes indicative of one or more features of the area. The method also includes comparing the one or more map attributes to at least one reference attribute, and based on the one or more map attributes matching the at least one reference attribute, causing the vehicle to enter a second operating state when the vehicle is in the area.

In addition to one or more of the features described herein, the one or more map attributes include a road grade, the at least one reference attribute is a threshold grade, and causing the vehicle to enter the second operating state includes changing an amount of torque available to the vehicle from a nominal torque.

In addition to one or more of the features described herein, the one or more map attributes include an area classification, the method further comprising maintaining the vehicle at the second operating state for a period of time in which the vehicle is in the area.

In addition to one or more of the features described herein, the one or more map attributes include a road type, the method further comprising maintaining the vehicle at the second operating state for a period of time in which the vehicle is on a road that matches the road type.

In addition to one or more of the features described herein, the one or more map attributes include at least one of an unpaved road attribute and an off-road attribute, the off-road attribute identified from an off-road trail map, and the second operating state is an off-road mode.

In addition to one or more of the features described herein, the one or more map attributes include a curvature, and causing the vehicle to enter the second operating state includes adjusting suspension settings of the vehicle.

In addition to one or more of the features described herein, the method further includes identifying a condition of a portion of the area, and based on the vehicle entering the portion of the area, causing the vehicle to temporarily enter a third operating state.

In addition to one or more of the features described herein, the portion of the area is a portion having a grade that is steeper than a grade of one or more other portions of the area.

In addition to one or more of the features described herein, the at least one reference attribute includes an area type attribute, and causing the vehicle to enter the second operating state includes limiting an amount of torque available to the vehicle according to a torque threshold when the vehicle is located in the area.

In addition to one or more of the features described herein, the method further includes identifying a portion of the area for which an increased amount of torque is desired, and temporarily increasing the torque threshold while the vehicle is within the portion of the area.

In addition to one or more of the features described herein, the map data is acquired from at least one of a map service, vehicle manufacturer information, a road classification module and user input.

In addition to one or more of the features described herein, data from the map service is stored in a first database, and data from at least one of the vehicle manufacturer information, the road classification module and the user input is stored in a second database accessible to the vehicle.

In one exemplary embodiment, a system for controlling operation of a vehicle includes a processing unit configured to monitor at least one of a location and a route of the vehicle when the vehicle is in a first operating state, and an input unit configured to receive map data related to an area around at least one of the location and the route. The system also includes a control unit configured to monitor at least one of the location and the route of the vehicle when the vehicle is in a first operating state, receive map data related to an area around at least one of the location and the route, identify one or more map attributes indicative of one or more features of the area based on the map data, compare the one or more map attributes to at least one reference attribute, and based on the one or more map attributes matching the at least one reference attribute, cause the vehicle to enter a second operating state when the vehicle is in the area.

In addition to one or more of the features described herein, the one or more map attributes include a road grade, the at least one reference attribute includes a threshold grade, and the control unit is configured to cause the vehicle to enter the second operating state by changing an amount of torque available to the vehicle from a nominal torque.

In addition to one or more of the features described herein, the one or more map attributes include an area classification, and the control unit is configured to maintain the vehicle at the second operating state for a period of time in which the vehicle is in the area.

In addition to one or more of the features described herein, the one or more map attributes include a road type, and the control unit is configured to maintain the vehicle at the second operating state for a period of time in which the vehicle is on a road that matches the road type.

In addition to one or more of the features described herein, the control unit is configured to identify a condition of a portion of the area, and based on the vehicle entering the portion of the area, cause the vehicle to temporarily enter a third operating state.

In one exemplary embodiment, a vehicle system includes a memory having computer readable instructions, and a processing device for executing the computer readable instructions, the computer readable instructions controlling the processing device to perform a method that includes monitoring at least one of a location and a route of the vehicle when the vehicle is in a first operating state, receiving map data related to an area around at least one of the location and the route, and identifying, based on the map data, one or more map attributes indicative of one or more features of the area. The method also includes comparing the one or more map attributes to at least one reference attribute, and based on the one or more map attributes matching the at least one reference attribute, causing the vehicle to enter a second operating state when the vehicle is in the area.

In addition to one or more of the features described herein, the method further includes identifying a condition of a portion of the area, and based on the vehicle entering the portion of the area, causing the vehicle to temporarily enter a third operating state.

In addition to one or more of the features described herein, the portion of the area is a portion having a grade that is steeper than a grade of one or more other portions of the area.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including various processing devices, in accordance with an exemplary embodiment;

FIG. 2 depicts a computer system, in accordance with an exemplary embodiment;

FIG. 3 depicts a vehicle control system including components for control of vehicle operation and/or state, in accordance with an exemplary embodiment;

FIG. 4 is a flow diagram depicting aspects of a method of monitoring a vehicle and controlling vehicle operation based on map data; and

FIG. 5 depicts an example of a method of monitoring a vehicle and controlling vehicle operation based on map data.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Devices, systems and methods are provided for automated or semi-automated vehicle control, including control of vehicle operation or behavior, based on map data representing a geographic area. An embodiment of a method of vehicle control includes acquiring map data related to an area in which a vehicle is located or heading toward, and controlling or changing a vehicle operating state based on map attributes acquired from the map data.

An embodiment of a vehicle control device or system is configured to acquire map data for a geographical area in which the vehicle is located or moving toward, and identify one or more map attributes from map data representing the area. Map data may include information and/or representations of roads that traverse an area. Map attributes include additional information that describes features of the area in addition to road representations. Examples of map attributes include road classifications, road conditions, trajectories or curvatures, surface types, traffic control features, area types and others.

Map data may be acquired from any suitable source, such as an imbedded navigation map, an automated driving map, a map database and others. In an embodiment, the control system maintains and/or accesses a database or other storage that stores sets of map attributes (reference attributes), and relates each set of map attributes to a vehicle operating state. For example, a look-up table may be utilized to determine a vehicle operating state.

The control system is configured to identify one or more map attributes from the map data, and compare the identified map attribute(s) to a set (i.e., one or more) of reference attributes. If one or more identified map attributes match a reference attribute, the system causes the vehicle to change from a first operating state (also referred to as an “initial operating state”) to a second operating state (also referred to as a “target operating state”). An operating state refers to a vehicle state in which the vehicle has a selected set of capabilities or behaviors. An operating state may be a pre-configured driving mode (e.g., normal, power limited, performance, off-road and others), or be any state corresponding to one or more vehicle components or capabilities. An operating state may be a vehicle state in which one or more components of the vehicle are limited, enhanced or otherwise controlled in response to one or more matching attributes.

Based on the identified map attributes of an area, the vehicle may be operated according to an operating state while the vehicle is within the area. It is noted that changes in operating state may be discrete (e.g., switching between pre-configured driving modes), or gradual. A gradual change in operating state may be accomplished by adding or removing individual capabilities, and/or by gradually changing a vehicle capability (e.g., gradually changing suspension properties and/or available torque as road grade changes).

Embodiments described herein present numerous advantages and technical effects. The embodiments increase safety and drivability by automatically modifying vehicle capabilities to conform to a given area. For example, available torque or other capabilities can be limited, in order to limit the ability of the vehicle and driver to perform certain maneuvers (e.g., accelerating too quickly or driving too fast), or otherwise operate in a manner that would be inappropriate or undesirable in a given context. In addition, embodiments do not require a driver to affirmatively change vehicle operating states or driving modes, thereby reducing potential distraction. Furthermore, vehicle behavior can be controlled based on a potentially large number of different map attributes, allowing the system to react and customize vehicle operation according to a large number of contexts, and can thus be used in complex scenarios.

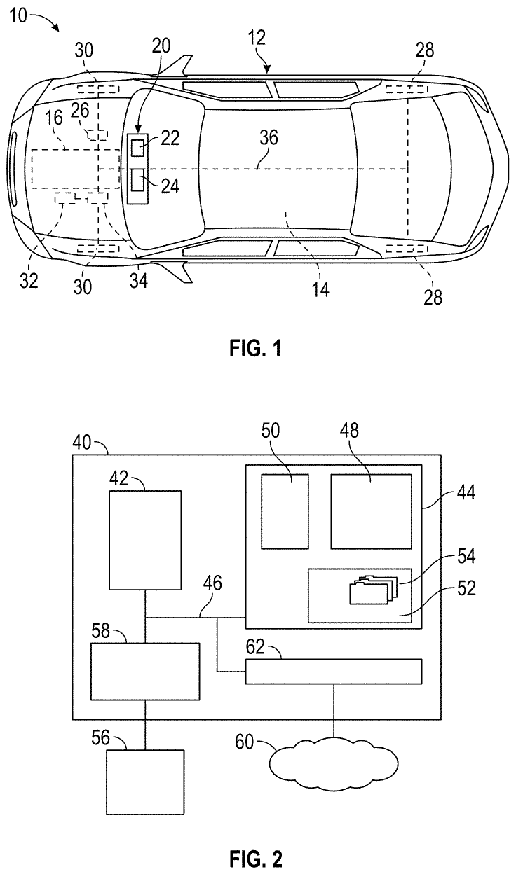

FIG. 1 shows an embodiment of a motor vehicle 10, which includes a vehicle body 12 defining, at least in part, an occupant compartment 14. The vehicle body 12 also supports various vehicle subsystems including an engine assembly 16, and other subsystems to support functions of the engine assembly 16 and other vehicle components, such as a braking subsystem, a suspension system, a steering subsystem, a fuel injection subsystem, an exhaust subsystem and others.

The vehicle 10 also includes one or more on-board processing devices and/or systems. For example, the vehicle 10 includes a computer system 20 that includes one or more processing devices 22 and a user interface 24. The vehicle 10 may also include additional processing devices for control of various subsystems. For example, an electronic brake control module (ECBM) 26 is part of the braking subsystem, and controls or regulates operation of the vehicle's rear brakes 28 and front brakes 30.

The vehicle 10 may also include a torque or power control system connected to the engine assembly 16 for limiting vehicle power based on map data as discussed herein. It is noted that, if the vehicle 10 is an electric vehicle, the control system is connected to the vehicle motor. Other control systems may be included, such as a speed control system, steering control system, suspension control system and others.

An embodiment of a control system includes a powertrain control module or controller 32, which may be part of the computer system 20 or at least in communication with the computer system 20. The powertrain control module 32, in an embodiment, is configured to communicate with an engine controller 34 (or motor controller in the case of an electric vehicle).

The various processing devices and units may communicate with one another via a communication device or system, such as a controller area network (CAN) or transmission control protocol (TCP) bus 36.

FIG. 2 illustrates aspects of an embodiment of a computer system 40 that can perform various aspects of embodiments described herein. The computer system includes at least one processing device, which generally includes one or more processors for performing aspects of monitoring and control methods described herein. The processing device can be integrated into the vehicle 10, for example, as an onboard processor such as the one or more processing devices 22, and/or can be a subsystem processing device such as the powertrain control module 32. The computer system may include multiple processing devices that operate in conjunction. For example, aspects of methods described herein can be performed by the powertrain control module 32 in cooperation with other vehicle subsystems, such as engine control units (ECU) and/or a transmission control unit (TCU).

Referring to FIG. 2, the computer system 40 includes a processing device 42 (such as one or more processors or processing units), a system memory 44, and a bus 46 that couples various system components including the system memory 44 to the processing device 42. The system memory 44 may include a variety of computer system readable media. Such media can be any available media that is accessible by the processing device 42, and includes both volatile and non-volatile media, removable and non-removable media.

For example, the system memory 44 includes a storage system 48 for reading from and writing to a non-removable, non-volatile memory (e.g., a hard drive). The system memory 44 may also include volatile memory 50, such as random access memory (RAM) and/or cache memory. The vehicle processing system 40 can further include other removable/non-removable, volatile/non-volatile computer system storage media.

The system memory 44 includes at least one program product having a set (e.g., at least one) of program modules that are configured to carry out functions of the embodiments described herein. For example, the system memory 44 stores a program 52 or set of programs, and/or various processing modules 54. At least one processing module may be configured to execute one or more control algorithms for performing the methods described herein. For example, the processing modules 54 can include modules for performing various functions, such as acquiring map data, acquiring detection or monitoring data, categorizing areas, controlling vehicle operating states, controlling and/or communicating with other devices, and/or controlling other aspects of vehicle operation. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 40 can also communicate with one or more external devices 56, such as vehicle components and other control units in the vehicle 10. Communication with various devices can occur via Input/Output (I/O) interfaces 58.

The processing device 40 may also communicate with one or more networks 60 such as a local area network (LAN), a CAN network, a cellular network, a wide area network (WAN), and/or a public network (e.g., the Internet) via a network adapter 62. It should be understood that although not shown, other hardware and/or software components could be used in conjunction with the computing system 40. Examples include, but are not limited to: microcode, device drivers, redundant processing units, external disk drive arrays, RAID systems, and data archival storage systems, etc.

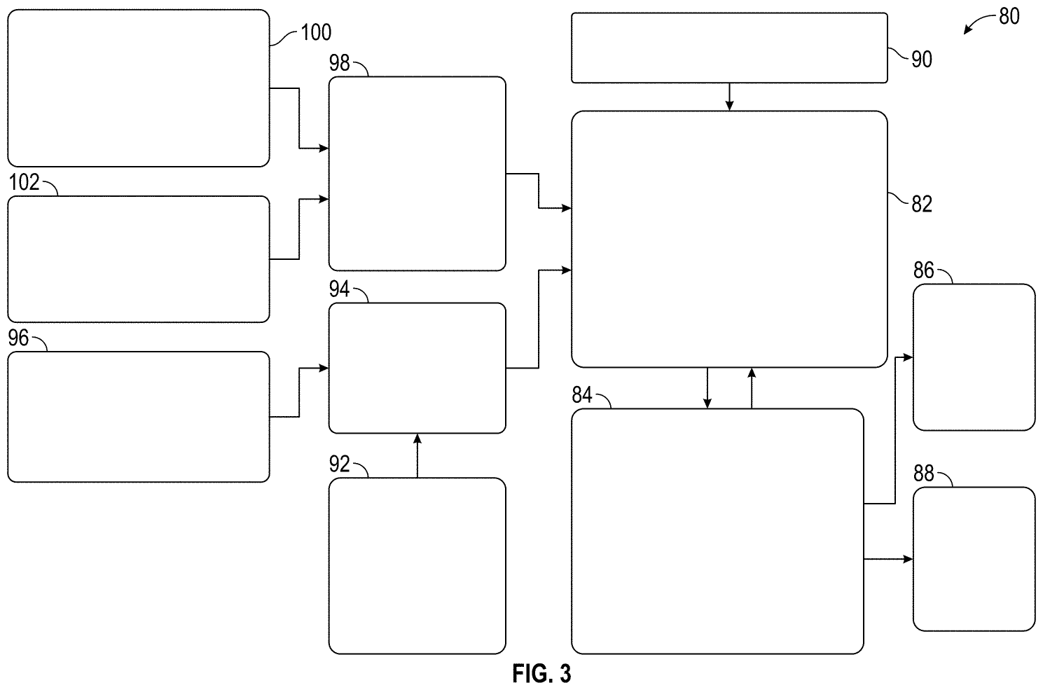

FIG. 3 depicts an embodiment of a vehicle control system 80 including various processing modules for performing aspects of vehicle control described herein. Embodiments are discussed herein in conjunction with an example in which a target vehicle operating state is achieved by limiting or controlling torque of a vehicle engine or motor based on an “area type” map attribute. The embodiments are not so limited, as the method may be applied to control any number of vehicle components and behaviors, based on any combination of one or more map attributes.

The system 80 includes a localizing module 82 that receives input data including map data, vehicle location data, vehicle route data and/or other relevant information. The localizing module 82 compares the vehicle location and/or route data to identify a geographic area that the vehicle is within or moving to. Map data representing the area is acquired, and one or more map attributes are extracted. In an embodiment, the localizing module 82 extracts an area type attribute from the map data, and compares the extracted attribute to a reference attribute.

For example, if the extracted area type is residential, the localizing module inspects a database or other storage to determine whether the stored data includes a reference attribute indicating the same or similar area type. If the extracted and reference area types match, the localization module 82 communicates with appropriate vehicle systems or units to cause the amount of torque to be limited to be less than or equal to a selected threshold while the vehicle is in the area, which is lower than the full available torque or the amount of torque available in an initial state.

In an embodiment, the localization module 82 is configured to communicate with a system or unit for controlling vehicle components, such as engine or motor torque. For example, the system 80 includes a powertrain controller 84, which may be any suitable processing device or system. For example, the powertrain controller 84 may be at least part of the powertrain control unit 32 shown in FIG. 1.

The powertrain controller 84 is configured to receive a command or request (e.g., a state transition request), and change an engine or motor state from a first or initial state to a second state or target state. For example, the state transition request is generated to cause the engine or motor torque to be limited to a threshold level. The target state may be configured specifically for a given context, or may be a pre-configured vehicle state. For example, the vehicle can be put into a limited power state in which torque is limited to a threshold when the vehicle enters a residential area. The torque limit may be adjusted or customized based on characteristics of the area such as population density, speed limit and road grade. In addition, the torque limit may be dynamically adjusted during operation as characteristics change (e.g., road grade becomes steeper or shallower).

In an embodiment, the powertrain controller 84, upon receiving the command or request, determines whether there are any reasons (e.g., a diagnostic problem) why a state change should not occur. If no such reasons are identified, the powertrain controller 84 sends a state transition command to a vehicle controller, such as an engine controller 86 or a motor controller 88 (for an electric or hybrid vehicle).

Input data may be received from a variety of sources. For example, location information is received from a vehicle module 90. Map data and map attributes may be received from a map database 92, such as a vehicle maps service (VMS), a GPS system or other public maps database. In some cases, map data from the database 92 includes road classifications and/or map region categories.

Other inputs may also be received and used for changing the vehicle operating state. In an embodiment, a user or driver may input information (represented by block 100), such as roads known to the user that are not already in the database 92 (e.g., dirt roads, new roads). A user may, for example, input new roads and select road type (e.g., from a drop down menu in a physical or virtual interface). Other inputs may include information from a vehicle manufacturer (represented by block 102), such as locations or regions that match a list of known electric vehicle (EV) only areas.

In an embodiment, the system 80 includes a road classification module 94 that identifies the current location of a vehicle and determines a road classification. The road classification may be determined based on existing map data (e.g., road class information provided by a maps service) or by analysis (e.g., machine learning classifiers). If a route planner 96 is available, the route planner 96 may determine whether a user has entered a route or destination into a navigation system (e.g., in the vehicle or in a user device). If so, information from the route planner 96 is provided to the road classification module 94.

Thus, in an embodiment, the localization module 82 receives input data including map data (e.g., from the database 92 and/or the database 98), vehicle location (e.g., from the module 90), and route information (e.g., from the route planner 96 and/or the road classification module 94). If available, road classifications from the database 92 may be used to determine whether the location or route of the vehicle is within an area associated with a target vehicle state.

As noted above, the change in the vehicle state is performed by matching extracted map attributes to reference attributes. Map attributes include any features or elements of an area represented by map data, which are stored in addition to road layout or coordinate information. Examples of map attributes include speed limit, road class, whether a road is classified or unclassified, road type, road condition (e.g., worn, damaged, under construction, etc.), road curvature, elevation, grade, surface type (e.g., paved or dirt), area type (e.g., rural, urban, neighborhood, EV only, etc.) and others.

Other examples of road types include controlled access divided roads, interchange links, non-controlled access divided roads, controlled access non-divided roads, access ramps, non-divided non-controlled access roads, local marked roads, unmarked or unclassified roads, and others. Further examples of road types include motorway, trunk, primary, secondary, tertiary, residential and service road types. Any combination of one or more map attributes, optionally in combination with other data (e.g., sensor data, objects identified via image analysis, inputs from a user or driver, etc.), may be used to determine whether to put into a target operating state.

Other information may be utilized to determine whether to change a vehicle operating state, such as new roads not indicated by the map data, and objects in the area (e.g., pedestrians, other vehicles). Such other information can be received via map data, user input or other sources of information. For example, if an area is of the residential or neighborhood area type and a road classification is residential, or map data indicates a congested area or roads that have tight turns, the vehicle may be put into a limited power state or other operating state.

For example, a vehicle is put into a “limited power state” in which torque is limited to a threshold for a specific duration (e.g., while the vehicle is in an area, on a specific road, or on a specific part of a road). It is noted that a limited power state for a given area may not prescribe the same limit as another area. In addition, the limited power state for a given area may prescribe other operational capabilities. For example, a neighborhood in a given location may have a different torque limit than another neighborhood, due to differences in population density, road type, speed limit and/or other features (e.g., is the neighborhood hilly or not). In another example of a limited power state for a delivery vehicle, torque is limited and the vehicle is allowed to move even when a vehicle door is open and the driver's seat belt is disengaged.

The following is an example of a situation in which a vehicle is put into a target operating state that includes torque limiting. In this example, a delivery vehicle, upon entering a residential area, transitions to a neighborhood delivery mode, in which torque is limited and a shift pattern is optimized for speed below about 25 mile-per-hour (MPH) driving. In the delivery mode, other vehicle functions are allowed, such as driving with a door open and seat belt disengaged. Additionally, the delivery mode could increase the available torque if an uphill grade is present in the map, for the portion of the vehicle route that is on the uphill grade. In some situations, peak torque may be limited for durability concerns, but peak torque could be momentarily expanded for this hill.

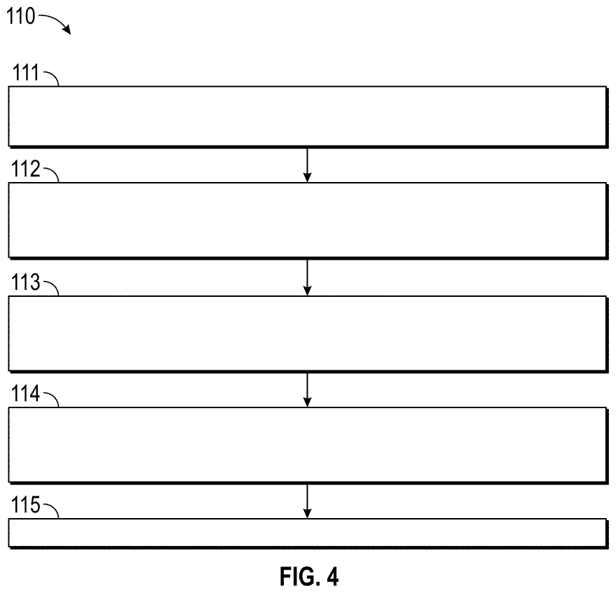

FIG. 4 illustrates embodiments of a method 110 of controlling operation of a vehicle and limiting vehicle torque or power. The method 110 may be performed by a processor or processors disposed in a vehicle (e.g., as an ECU or on-board computer, and/or an EBCM). The method 110 is discussed in conjunction with blocks 111-115. The method 110 is not limited to the number or order of steps therein, as some steps represented by blocks 111-115 may be performed in a different order than that described below, or fewer than all of the steps may be performed.

The method 110 is discussed in conjunction with the vehicle of FIG. 1 and a processing system, which may be, for example, the computer system 40, the on-board processor 22, the ECBM 26, or a combination thereof. Aspects of the method 100 are discussed in conjunction with the power control system 80 for illustration purposes. It is noted the method 100 is not so limited and may be performed by any suitable processing device or system, or combination of processing devices.

At block 111, vehicle location is monitored (e.g., via the module 90) while the vehicle is in a first or initial operating state. For example, the vehicle may initially be in a wide open throttle (WOT) mode, or other mode that allows for full torque availability. Route information may also be monitored or acquired, for example, via the route planner 96.

At block 112, a processing device such as the localization module 82 acquires map data (including map attributes) from various sources, such as a map service, GPS data, database accessible to the vehicle (e.g., public map services, GPS data and/or a database maintained by the vehicle), or a network accessible to the vehicle. Map data may include data directly accessible from maps, and any other information relevant to determination as to whether torque should be limited or the vehicle should otherwise be put into a target operating state, such as vehicle sensor data (e.g., camera, radar), planning data, image analysis data, etc.

The processing device extracts map attributes from the map data, and compares the map attributes to reference attributes.

At block 113, based on one or more extracted map attributes matching one or more reference attributes, the processing device determines a target operating state. For example, a look-up table or other data structure relates individual reference attributes or a combination of reference attributes to a target operating state. The processing device determines whether one or more extracted map attributes match a stored reference attribute (or attributes). If a match is found, the processing device puts the vehicle into the target operating state.

For example, if the processing system extracts a map attribute indicating a residential area, the processing system inspects the stored information for a residential area attribute (or similar attribute such as urban or high density) and determines that the operating state should be a limited torque or power state in which vehicle power should be reduced (e.g., to increase safety and prevent a driver from accelerating too quickly). In the limited state, the available torque is maintained at or below and selected threshold.

For example, a vehicle may have an initial operating state in which 500 horsepower (hp) or 500 foot-pounds (ft-lb) of torque is available at the pedal. The vehicle is put into a limited operating state in which the available torque is limited to a threshold of 100 ft-lbs or less. Such a limit greatly increases safety in preventing the vehicle from accelerating too quickly. Thus, an accidental foot slip that could uncontrollably launch the vehicle would only result in a vehicle lurch.

In the example of FIG. 3, the localizing module 82 receives, location, route, road and database information, and cross-checks the current location and destination (optionally route information). If route planning is used, the localizing module may also cross-check transition points. The localizing module 82 then sends a powertrain state transition request to the powertrain controller 84, which checks for any diagnostic issues or any other condition that would affect or preclude torque limiting. If no such issues or conditions arise, the powertrain controller 84 sends a transition command to an appropriate engine or controller.

In an embodiment, the map data is modified to indicate the bounds of the area that has been assigned the target operating state. For example, a geofence or boundary around the area is stored digitally, as part of map data or otherwise.

At block 114, in an embodiment, the processing system determines whether there is a condition for which a modification of the target operating state would be beneficial. For example, when the vehicle is in the area and in a limited power or torque operating state, map data, image data and/or other information is used to determine if there is a steep grade that may need more power. If a portion of the area is in such a condition (e.g., a road or length of a road has a grade that is steeper than surrounding portions, or steeper than a selected threshold), the vehicle is put into a third operating state in which the threshold is temporarily increased or the vehicle is temporarily put into another mode.

In this way, the processing device temporarily increases the amount of available power while the vehicle is in the portion of the area. For example, when the vehicle is at a road having a steep grade, the torque threshold is increased so that sufficient power is supplied to allow the vehicle to traverse the grade. Upon the condition ending (e.g., vehicle crests the hill or grade), the vehicle is returned to the limited power state or the threshold is returned to a previous value.

At block 115, the vehicle is returned to the first operating state. That may happen due to the vehicle leaving the area, or user input requesting that the vehicle return to a previous state (e.g., in which full power or torque is available.

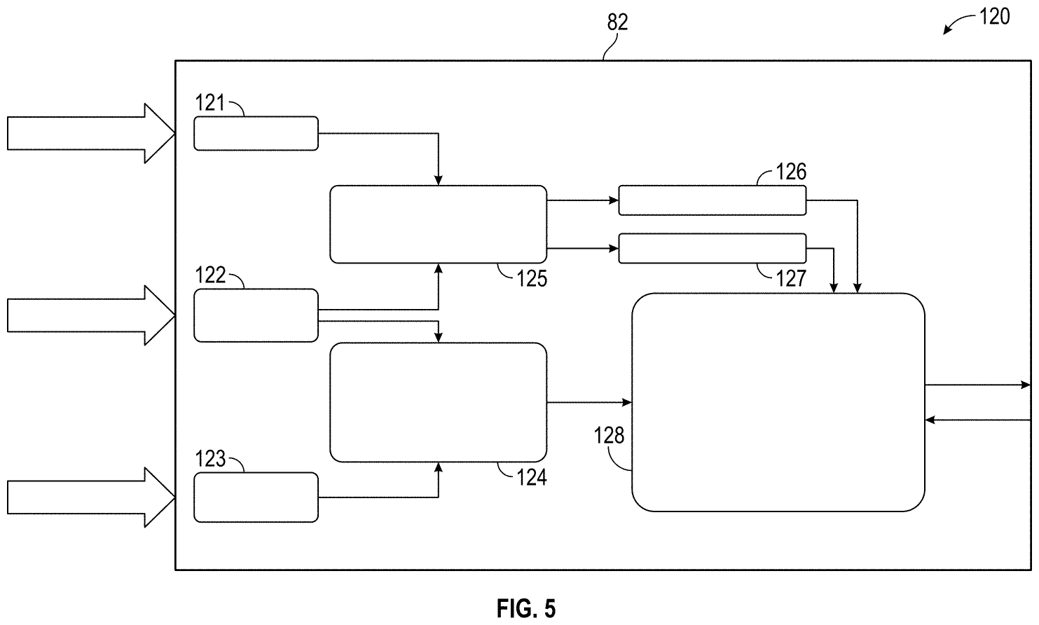

FIG. 5 depicts an embodiment of the localization module 82 and an example of a method 120 of controlling vehicle operation. The method 120 may be considered an example of at least part of the method 110.

The method 120 is discussed in conjunction with blocks 121-128. The method 120 is not limited to the number or order of steps therein, as some steps represented by blocks 121-128 may be performed in a different order than that described below, or fewer than all of the steps may be performed.

In the method 120, input data is transmitted to the localization module 82. Examples of input data include database information (block 121) and vehicle location (block 122). The database information may include map data from a map service (e.g., at database 92) and/or from a database or other storage location (e.g., the database 98). Route information may be acquired, for example, from a planning module and/or user input. For example, a user may input route information (e.g., a destination) at block 123. At block 124, a planner or other module creates an optimized or desired route based on current location needs and future needs (e.g., when fuel or battery charging would be needed).

At block 125, the current location of the vehicle is compared to map data from, for example, the database 92 and/or 98. Map data including attributes is extracted for an area in which the vehicle is located or an area in which the route traverses. If one or more map attributes match one or more reference attributes, a state transition command (block 126) is sent to an optimizer. If not, the current state of the vehicle is maintained (block 127).

At block 128, the optimizer receives the state transition command (if applicable), as well as the current powertrain state and route information including powertrain transition points (from block 124). The optimizer decides whether to maintain the current state or transition to a target (e.g., limited power state) based on the command. In an embodiment, the localizer also determines whether the powertrain needs are or will be different than that provided in the target operating state. If the decision is negative, the optimizer sends a powertrain state command to cause the vehicle to enter the target state.

Map attributes may also be extracted from other types of maps, such as off-road trail maps. In an embodiment, a processing device uses off-road trail map attributes to automatically adjust off-road abilities. For example, operating states can be changed from normal to a high range off-road mode or a low range off-road mode (e.g., rock crawl mode).

The following are additional examples of controlling vehicle behavior and/or operating state based on map attributes according to embodiments described herein. The examples may be performed by a vehicle computer system, such as the system 80, or by any suitable processing device or system. In the following examples, a processing device acquires map data for a given area and extracts map attributes. The extracted attributes are compared to reference attributes stored in a database, in which each reference attribute or set of attributes relates to a vehicle operating state. As discussed, the operating state may be a pre-configured state, or the operating state may be defined by a single vehicle capability or a combination of capabilities. As noted above, the operating state may be a discrete state such as a driving mode, or the operating state may be changed gradually or dynamically as conditions change.

In one example, a delivery vehicle enters or approaches a residential area while in a normal operating state. This may be determined based on attributes that indicate an area type (e.g., residential) and/or a road type. In this example, the extracted attribute indicates a Class 4 or 5 road. The vehicle is put into a “delivery mode”, in which available torque is reduced by 25%, open door operation is enabled, and contactor remain closed key off behavior (in which the vehicle battery remains energized and the battery contactor is closed when the ignition key is removed) is enabled.

In another example, if the map attributes indicate any classified road, raised vehicle states are limited. In yet another example, if the vehicle is in an area associated with any classified road, side mirror puddle lamps are disengaged. It is noted that other vehicle features such as interior lights may be controlled according to extracted map attributes.

In a further example, if the vehicle is on or approaching a dirt road (indicated by a map attribute), the vehicle transitions from an initial state to a target state referred to as an off-road mode. In the off-road mode, features such as accelerator response, torque and traction control are controlled specifically for driving on a non-paved road. In addition to, or alternatively, the target state may include disengagement of active aerodynamic components

In another example, map attributes including speed limit are used to control vehicle states. The processing device can utilize speed limit data from the map data to automatically change operating states by changing vehicle configuration such as suspension settings and torque settings.

In other examples, the processing device can use off-road trail map attributes to adjust brake sensitivity (e.g., up-hill grade vs down-hill grade). The processing device can also use forward looking off-road or on-road map grade information (e.g., e-horizon data) to determine effective regenerative braking techniques. Forward looking map data can be used to automatically adjust suspension settings for road objects such as speed bumps, railroad crossings, potholes, steep driveway entrances, etc.

In a further example, map attributes indicative of curvature, grade and/or cross slope are extracted and matches to stored reference attributes. Based on these attributes, suspension settings may be adjusted. If the vehicle is travelling on a road having a variable curvature and/or variable grade, vehicle capabilities may be gradually changed (e.g., torque increased with an increase in grade and decreased with a decrease in grade).

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of controlling operation of a vehicle, comprising:
monitoring at least one of a location and a route of the vehicle when the vehicle is in a first operating state;
receiving map data related to an area around at least one of the location and the route;
identifying, based on the map data, one or more map attributes indicative of one or more features of the area;
comparing the one or more map attributes to at least one reference attribute; and
based on the one or more map attributes matching the at least one reference attribute, causing the vehicle to enter a second operating state when the vehicle is in the area.

2. The method of claim 1, wherein the one or more map attributes include a road grade, the at least one reference attribute is a threshold grade, and causing the vehicle to enter the second operating state includes changing an amount of torque available to the vehicle from a nominal torque.

3. The method of claim 1, wherein the one or more map attributes include an area classification, the method further comprising maintaining the vehicle at the second operating state for a period of time in which the vehicle is in the area.

4. The method of claim 1, wherein the one or more map attributes include a road type, the method further comprising maintaining the vehicle at the second operating state for a period of time in which the vehicle is on a road that matches the road type.

5. The method of claim 1, wherein the one or more map attributes include at least one of an unpaved road attribute and an off-road attribute, the off-road attribute identified from an off-road trail map, and the second operating state is an off-road mode.

6. The method of claim 1, wherein the one or more map attributes include a curvature, and causing the vehicle to enter the second operating state includes adjusting suspension settings of the vehicle.

7. The method of claim 1, further comprising identifying a condition of a portion of the area, and based on the vehicle entering the portion of the area, causing the vehicle to temporarily enter a third operating state.

8. The method of claim 7, wherein the portion of the area is a portion having a grade that is steeper than a grade of one or more other portions of the area.

9. The method of claim 1, wherein the at least one reference attribute includes an area type attribute, and causing the vehicle to enter the second operating state includes limiting an amount of torque available to the vehicle according to a torque threshold when the vehicle is located in the area.

10. The method of claim 9, further comprising identifying a portion of the area for which an increased amount of torque is desired, and temporarily increasing the torque threshold while the vehicle is within the portion of the area.

11. The method of claim 1, wherein the map data is acquired from at least one of a map service, vehicle manufacturer information, a road classification module and user input.

12. The method of claim 11, wherein data from the map service is stored in a first database, and data from at least one of the vehicle manufacturer information, the road classification module and the user input is stored in a second database accessible to the vehicle.

13. A system for controlling operation of a vehicle, comprising:
a processing unit configured to monitor at least one of a location and a route of the vehicle when the vehicle is in a first operating state;
an input unit configured to receive map data related to an area around at least one of the location and the route; and
a control unit configured to monitor at least one of the location and the route of the vehicle when the vehicle is in a first operating state, receive map data related to an area around at least one of the location and the route, identify one or more map attributes indicative of one or more features of the area based on the map data, compare the one or more map attributes to at least one reference attribute, and based on the one or more map attributes matching the at least one reference attribute, cause the vehicle to enter a second operating state when the vehicle is in the area.

14. The system of claim 13, wherein the one or more map attributes include a road grade, the at least one reference attribute includes a threshold grade, and the control unit is configured to cause the vehicle to enter the second operating state by changing an amount of torque available to the vehicle from a nominal torque.

15. The system of claim 13, wherein the one or more map attributes include an area classification, and the control unit is configured to maintain the vehicle at the second operating state for a period of time in which the vehicle is in the area.

16. The system of claim 13, wherein the one or more map attributes include a road type, and the control unit is configured to maintain the vehicle at the second operating state for a period of time in which the vehicle is on a road that matches the road type.

17. The system of claim 13, wherein the control unit is configured to identify a condition of a portion of the area, and based on the vehicle entering the portion of the area, cause the vehicle to temporarily enter a third operating state.

18. A vehicle system comprising:
a memory having computer readable instructions; and
a processing device for executing the computer readable instructions, the computer readable instructions controlling the processing device to perform a method including:
monitoring at least one of a location and a route of the vehicle when the vehicle is in a first operating state;
receiving map data related to an area around at least one of the location and the route;
identifying, based on the map data, one or more map attributes indicative of one or more features of the area;
comparing the one or more map attributes to at least one reference attribute; and
based on the one or more map attributes matching the at least one reference attribute, causing the vehicle to enter a second operating state when the vehicle is in the area.

19. The vehicle system of claim 18, wherein the method further includes identifying a condition of a portion of the area, and based on the vehicle entering the portion of the area, causing the vehicle to temporarily enter a third operating state.

20. The vehicle system of claim 19, wherein the portion of the area is a portion having a grade that is steeper than a grade of one or more other portions of the area.
